(19) United States
(12) Patent Application Publication
(10) Pub. No.: US 2005/0283963 A1
(43) Pub. Date: Dec. 29, 2005

(54) Shoelace fastener

(76) Inventor: Geza Tomosy, Allentown, PA (US)

Correspondence Address: POWELL GOLDSTEIN LLP, ONE ATLANTIC CENTER, FOURTEENTH FLOOR 1201 WEST PEACHTREE STREET NW, ATLANTA, GA, 30309-3488, US

(21) Appl. No.: 10/875,830

(22) Filed: Jun. 24, 2004

(51) Int. Cl. B23P 19/04

(52) U.S. Cl. 29/433; 24/712

(57) ABSTRACT

A device for reducing knot slippage comprising a ring or tube segment having inner and outer walls forming an opening therein and top and bottom rims. Either one or both of the rims have a series of pointed protrusions extending from the rim. Laces passing through the opening and then knotted at least partially engage the protrusions, thereby reducing slippage of the knot and keeping the laces tied.

### FIELD OF THE INVENTION

The present invention relates to devices for maintaining shoelaces or other tied strings in a tied configuration.

### BACKGROUND OF THE INVENTION

Keeping shoelaces tied, particularly those of children, has been a perennial problem. While the footwear is being worn and actively used the laces that are tied may become untied due to knot slippage. A number of mechanical devices have been developed to address this problem. Also, a number of knotting techniques, from the simple to the complex, have also been designed. It would be desirable to have a simple device that could work with conventional shoelaces and use conventional knots that children the world over can use.

### SUMMARY OF THE INVENTION

The present invention remedies the deficiencies in the art and provides simple, low cost device for reducing knot slippage. Generally described, the present invention provides in a first exemplary embodiment a device for maintaining laces or strings in a tied configuration, comprising a generally annular ring segment having a top rim, a bottom rim, inner wall and outer wall defining a opening; and, a plurality of protrusions extending from and spaced around either one or both of the rims such that laces passed through the opening and at least partially tied engage the protrusions so as to reduce the tendency of the laces or strings to become loosened or untied. The protrusions preferably engage, e.g., bite into, the laces so as to hold the laces while tied. The protrusions may be pointed or rounded and may be of various configurations.

In use, the shoelaces may first be tied in an overhand knot. The lace ends are then passed through the opening in the device and a bow or other knot formed with the lace ends. When the knot is tightened the laces engage the protrusions. Slippage of the laces is reduced because of the increased friction and engagement of the protrusions.

Optionally, the device may incorporate a tether having an attachment means, such as a hook or T-shaped handle, which can be associated with the footwear, such as by inserting the attachment means through an eyelet in the footwear.

In one alternative exemplary embodiment a pair of concentric coaxial or side-by-side devices can be used to hold the laces in place after knotting.

A feature of the present invention is to provide a simple, easy to make and use device that will reduce knot slippage.

It is another feature of the present invention to provide a device that can be conveniently used on children's shoes to reduce knot slippage and untying.

Other features and advantages of the present invention will become apparent upon reading the following detailed description of embodiments of the invention, when taken in conjunction with the appended claims.

### BRIEF DESCRIPTION OF THE DRAWINGS

The invention is illustrated in the drawings in which like reference characters designate the same or similar parts throughout the figures of which:

FIG. 1 is a perspective view of the shoelace fastener according to one exemplary embodiment of the present invention.

FIG. 2 is a perspective view of the fastener showing additional details of the interior.

FIG. 3 is a side elevational view of the fastener of FIG. 2.

FIG. 4 is a perspective view of a fastener showing protrusions that are angled outward.

FIG. 5 is a schematic view of a fastener of FIG. 1 shown with laces in a partially knotted configuration with a half hitch knot proximate to the bottom rim protrusions.

FIG. 6 shows a schematic view of a fastener of FIG. 1 shown with laces knotted in a half hitch proximate to the bottom rim protrusions and in a bow knot proximate to the top rim protrusions.

FIG. 7 shows a schematic view of a fastener of FIG. 1 with both half hitch and bow knots being proximate to the top rim.

FIG. 8 shows a perspective view of a first alternative exemplary embodiment incorporating two coaxial rings.

FIG. 9 shows side perspective view of a second alternative exemplary embodiment incorporating two rings in a side-by-side configuration.

FIG. 10 shows an alternative embodiment of the fastener of FIG. 1 incorporating a tether.

FIG. 11 shows a schematic perspective view of an article of footwear incorporating a fastener of FIG. 1.

### DETAILED DESCRIPTION OF THE INVENTION

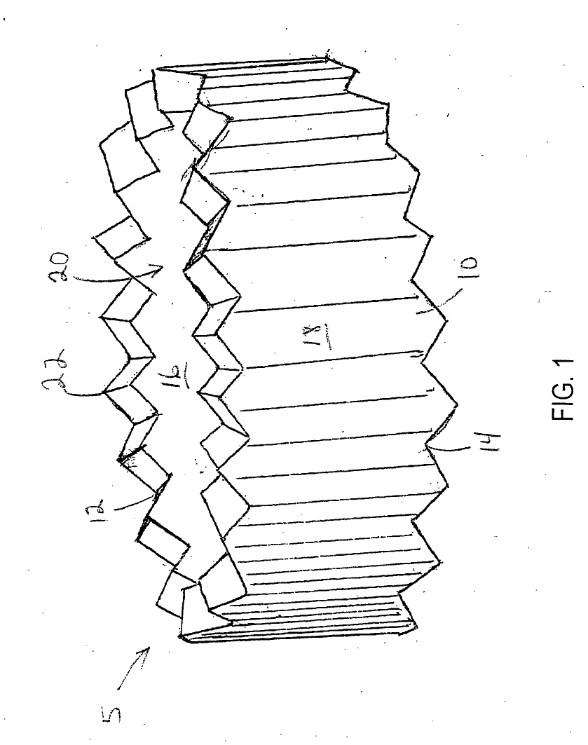

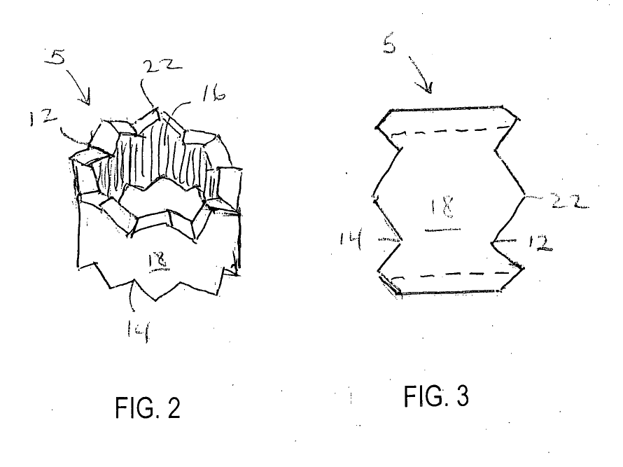

Generally described the present invention provides in a first exemplary embodiment, shown in FIGS. 1-7, and more particularly in FIGS. 1-3, a shoelace fastener device 5 for retaining laces 7 in a tied configuration; i.e., reducing the likelihood that the laces will become untied until it is desired to do so. The device may comprise a ring or tube 10. For the purposes of the present invention the term ring or tube is intended to mean a generally annular structure having a top rim 12 and bottom rim 14, an inner wall 16 and an outer wall 18 and a generally axial opening 20. The walls may be parallel, tapered, curved, rounded or otherwise configured. The circumference may be circular, ellipsoidal, square, rectangular, triangular, irregular, toroidal, irregular or regular polyhedron, smooth, rounded, or textured, or the like. The thickness of the wall may be uniform or varied from top to bottom end or therebetween. The outer and/or inner walls 16, 18 may have ridges, either axial or annular formed therein. The device 5 may be made of any suitable rigid or flexible material, such as, but not limited to plastic, rubber, composite, metal, ceramic, paper, natural fibers, wood, combinations of the foregoing, or the like. It is preferable that the device 5 be made of a material that will resist wear and stress. In one exemplary embodiment the device 5 is cut or formed from a vinyl or rubber hose or tubing.

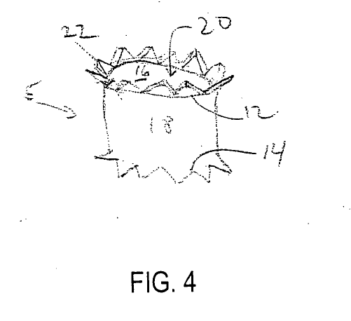

The top rim 12 has a series of protrusions 22 extending therefrom. The protrusions 22 preferably extend generally axially from the rim 12. For the purposes of the present invention the term protrusion shall mean a tooth, finger, ridge, bump, serration, complex regular or irregular shape, combinations or mixtures of the foregoing or the like. The protrusions 22 may be regular or irregular or may alternate or be of mixed shapes. In a preferred embodiment the protrusions 22 are sawtoothed and generally triangular in shape. It is preferable that the protrusions at least partially “bite” into or otherwise engage the lace 7 material when the laces are tied so as to reduce the tendency of the laces 7 to adjust their relative positions and become untied during wearing. The protrusions 22 may extend all axially from the rim 12 and or 14. Alternatively, as shown in FIG. 4, either all or a portion of the protrusions 22 may be angled outward, inward or a combinations of outward, inward and/or axially from the longitudinal axis of the tube 10. The protrusions may be made of the same material as described hereinabove with respect to the device 5 or may be made of a different material. It is preferable that the protrusions 22 be sufficiently rigid and strong as to be able to engage the laces repeatedly without appreciable wear to the protrusions. It is also preferable for the protrusions 22 to be designed to be sufficiently thick so as not to easily break off under stress or bending. This is not to say that the protrusions 22 may never break as some wear is to be expected.

While it is preferable that the bottom rim 14 also have protrusions 22, as described above, extending therefrom it is possible for only the top rim 12 or bottom rim 14 to have the protrusions 22.

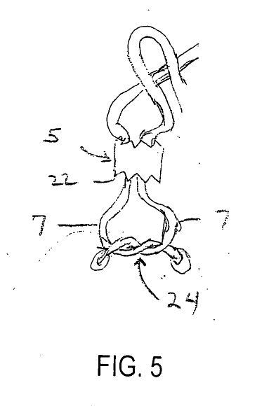

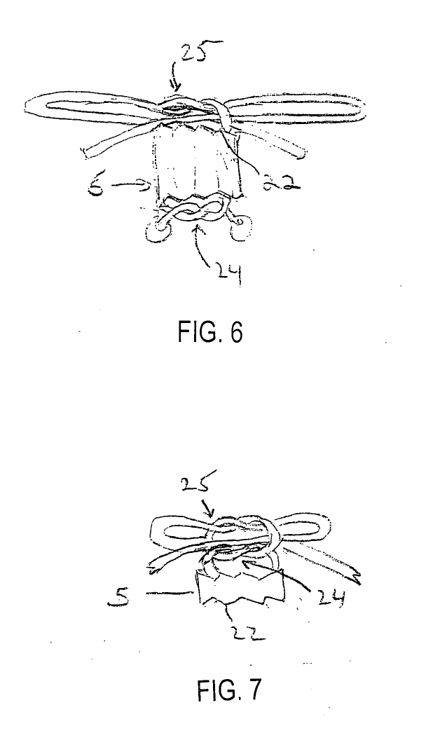

The present invention also provides a method of tying laces, comprising providing an article of footwear, e.g., a shoe, a lace or laces 7, tying a first knot 24 using the laces 7, for example, but not limited to, an overhand or half-hitch knot 24. As shown in FIG. 5, the free ends of the laces 7 are inserted through the opening 16 in the device 5. The laces 7 are pulled so as to cinch the device 5 on top of the first knot 24. In the case of a common bow knot 25 each lace end portion is formed into a loop and the loops are tied together to make a standard shoelace knot 25. The loops are pulled to tighten the knots 24, 25 to form an overall lace knot, shown in FIG. 6. The laces “bite” or engage the protrusions on the top and/or bottom rims 16, 18 thereby resulting in a knot that resists becoming untied during use. It is to be understood that other knots and/or lacing methods may be used with the present invention. When the wearer wishes to remove the footwear, the knots 24 and 25 are undone and the laces 7 loosened. The device 5 may be retained in proximity to the footwear by leaving the laces 7 in position in the opening 20.

In an alternative method of tying a shoelace 7 with the device 5, as shown in FIG. 7, the lace ends are passed through the opening 20 prior to the first knot 24 being tied. The lace ends 7 are then formed into the first knot (e.g., half-hitch) 24 and then the lace ends 7 formed into bows that are tied together in a bow knot 25 and pulled tight.

While there are various variations of the shoelace knot it is to be understood by those skilled in the art that any of a number of various knots can be tied and maintained in the tied configuration using the device 5 of the present invention.

It is to be understood that while a common use for the present invention is in the tying of shoelaces the device 5 can be used to secure other strings, cords, wires or the like in various applications, knot configurations and uses. Applications may include boating, rigging, rock or mountain climbing, tiedowns for various purposes, and the like. The size of the device 5 and the protrusions 22 may be scaled accordingly.

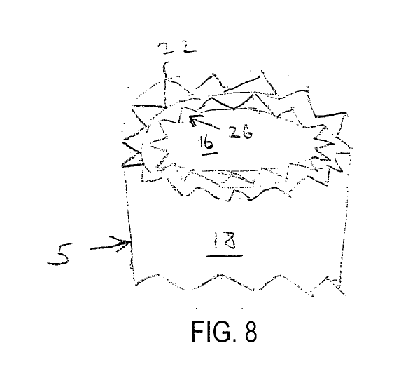

In an alternative exemplary embodiment, shown in FIG. 8, a pair of coaxial devices 5 and 26 may be used, each having a set of protrusions 22 extending from the top and/or bottom rims. In such an embodiment it is possible that the protrusions 22 of one device 5 are aligned with the protrusions 22 of the other device 26. Alternatively, at least a portion of the protrusions 22 of one device 5 may be offset from the protrusions 22 of the other device 26. This configuration may provide increased gripping action. The devices 5 and 26 may be maintained in a fixed relative position or may move with respect to each other.

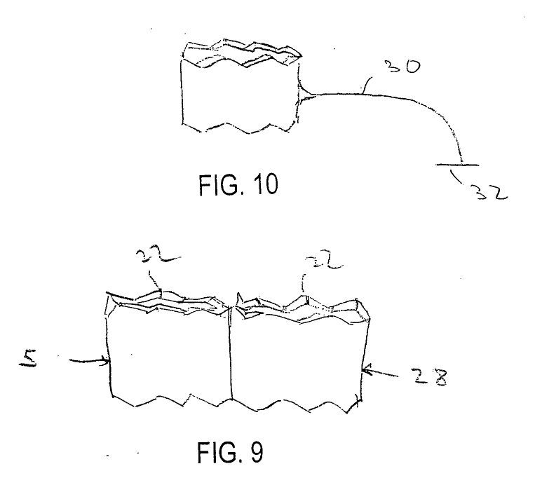

In a further alternative exemplary embodiment, shown in FIG. 9, a second device 28 can be associated with a first device 5 in a side-by-side arrangement. In such an embodiment the two devices 5 and 28 are attached to each other directly or via a connector.

In a further alternative exemplary embodiment, shown in FIG. 10, the device 5 (in any of the above-described embodiments) may incorporate a tether 30 extending from the device 5. The distal end 32 of the tether 30 can terminate in an attachment device 34 any of a variety of shapes or implements, such as, but not limited to, a T-shaped handle, a barb, hook, loop, clip, tie, combinations of the foregoing, or the like. The tether 30 can attach to the footwear, such as through an eyelet, to a lace or elsewhere, thereby helping to keep the device 5 from being disassociated with the footwear and getting lost.

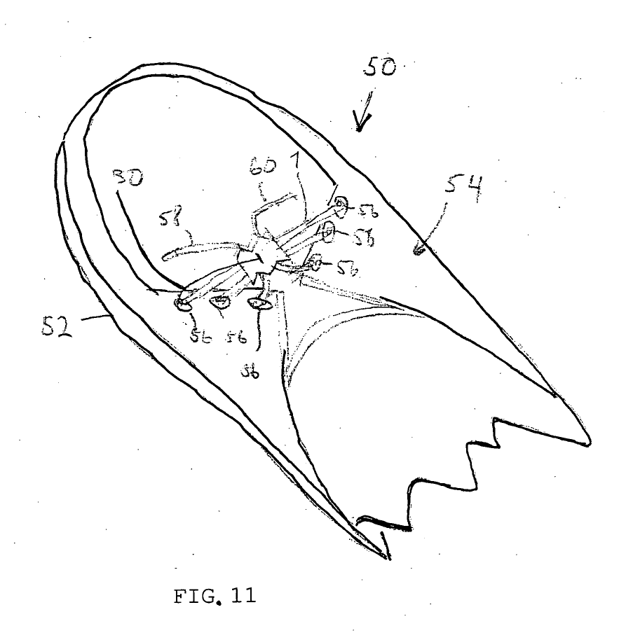

The present invention, as shown in FIG. 11, provides in an exemplary embodiment a novel article of footwear 50 comprising a sole 52, an upper portion 54 with at least two apertures 56, a lace 7 having a first end portion 58 and a second end portion 60, the lace portions being inserted into the apertures 56 and a device 5 as described hereinabove. Optionally, a tether 30 attached to the device 5 can be tethered to the upper portion 54 via an attachment means (not shown) as described hereinabove. The lace 7 can be knotted as described hereinabove.

Although only a few exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention as defined in the following claims.

It should further be noted that any patents, applications and publications referred to herein are incorporated by reference in their entirety.

1. A device for maintaining laces or strings in a tied configuration, comprising:
a) a generally annular ring segment having a top rim, a bottom rim, inner wall and outer wall defining a opening; and,
b) a plurality of protrusions extending from and spaced around at least one of said top or bottom rims such that laces passed through said opening and tied at least partially engage said protrusions so as to reduce the tendency of said laces or strings to become loosened or untied.

2. The device of claim 1, wherein said ring segment is tubular in shape.

3. The device of claim 1, wherein said ring segment has a cross-sectional shape selected from the group consisting of circular, ellipsoidal, square, rectangular, triangular, irregular, toroidal, irregular or regular polyhedron, smooth, rounded, or textured, and the like.

4. The device of claim 1, wherein said protrusions extend axially from said ring.

5. The device of claim 1, wherein a portion of said protrusions extend axially from said top and/or bottom rims and a portion of said protrusions extend at an angle outward or inward from said top and/or bottom rims.

6. The device of claim 1, further comprising a tether extending from said device and attachable to either said laces or another article.

7. The device of claim 6, wherein said tether terminates in a means for attaching said tether to an object.

8. The device of claim 7, wherein said tether attaching means comprises a T-shaped handle, a barb, hook, loop, clip, tie, or combinations of the foregoing.

9. A device for maintaining laces or strings in a tied configuration, comprising:
a) a first generally annular ring segment having a top rim, a bottom rim, inner wall and outer wall defining a opening and a plurality of protrusions extending from and spaced around at least one of said top or bottom rims such that laces passed through said opening and tied at least partially engage said protrusions so as to reduce the tendency of said laces or strings to become untied; and,
b) a second generally annular ring segment with said first annular ring segment and having a top rim, a bottom rim, inner wall and outer wall defining a opening and a plurality of protrusions extending from and spaced around at least one of said top or bottom rims such that laces passed through said opening and tied at least partially engage said protrusions so as to reduce the tendency of said laces or strings to become untied.

10. The device of claim 9, wherein said first ring is coaxial with said second ring.

11. The device of claim 9, wherein said first ring and said second ring are in a side-by-side configuration.

12. The device of claim 9, wherein said first and second rings are permanently joined into a one-piece, side by side, parallel configuration, providing a parallel but separate adjacent passages, one for said first end and one for said second end of said shoelace.

13. The device of claim 9, wherein said protrusions of said first ring segment are aligned with said protrusions of said second ring segment.

14. The device of claim 13, wherein at least a portion of said protrusions of said first ring segment are not aligned with said protrusions of said second ring segment.

15. A device for maintaining laces or strings in a tied configuration, comprising:
a) a generally annular ring segment having a top rim, a bottom rim, inner wall and outer wall defining a opening;
b) a plurality of protrusions extending generally axially from and spaced around at least one of said top or bottom rims such that laces passed through said opening and tied at least partially engage said protrusions so as to reduce the tendency of said laces or strings to become loosened or untied; and,
c) a tether having a first end associated with said outer wall and a second end, said second end terminating in a means for attaching said tether to an article of footwear.

16. An article of footwear, comprising:
a) a sole;
b) an upper footwear portion connected to said sole and defining at least two apertures;
c) at least one lace having first and second end portions that can be threaded through said at least two apertures; and,
d) a device for securing said first and second lace end portions when said end portions are tied, said device comprising,
i) a generally annular ring segment having a top rim, a bottom rim, inner wall and outer wall defining a opening, and,
ii) a plurality of protrusions extending from and spaced around at least one of said top or bottom rims such that laces passed through said opening and tied at least partially engage said protrusions so as to reduce the tendency of said laces or strings to become loosened or untied.

17. A method of securing laces in a tied configuration, comprising:
a) providing a lace having first and second lace end portions;
b) providing a device for maintaining laces or strings in a tied configuration, comprising,
i) a generally annular ring segment having a top rim, a bottom rim, inner wall and outer wall defining a opening, and,
ii) a plurality of protrusions extending from and spaced around at least one of said top or bottom rims such that laces passed through said opening and tied at least partially engage said protrusions so as to reduce the tendency of said laces or strings to become loosened or untied;
c) tying a first knot in said laces;
d) inserting said first and second lace end portions through said opening of said device;
e) tying a second knot with said first and second lace end portions that have passed through said opening such that at least a portion of said lace engages at least one of said protrusions; and,
f) tightening said second knot.

18. The method of claim 17, wherein said first knot is an overhand or half-hitch.

19. The method of claim 17, wherein said second knot comprises a pair of bows formed from each lace end portion that have been tied together.

20. A method of securing laces in a tied configuration, comprising:
a) providing a lace having first and second lace end portions;
b) providing a device for maintaining laces or strings in a tied configuration, comprising,
i) a generally annular ring segment having a top rim, a bottom rim, inner wall and outer wall defining a opening, and,
ii) a plurality of protrusions extending from and spaced around at least one of said top or bottom rims such that laces passed through said opening and tied at least partially engage said protrusions so as to reduce the tendency of said laces or strings to become loosened or untied;
c) inserting said first and second lace end portions through said opening of said device;
d) tying a first knot in said laces;
e) tying a second knot with said first and second lace end portions that have passed through said opening such that at least a portion of said lace engages at least one of said protrusions; and,
f) tightening said second knot.
